(19) United States
(12) Patent Application Publication
(10) Pub. No.: US 2026/0365538 A1
(43) Pub. Date: Nov. 19, 2026

(54) METHOD FOR MANUFACTURING A POSITIVE ELECTRODE ACTIVE MATERIAL

(71) Applicants: Umicore, Brussels (BE); UMICORE BATTERY MATERIALS FINLAND OY, Kokkola (FI)

(72) Inventors: Janne MARJELUND, Kokkola (FI); Ville HASSINEN, Kokkola (FI); Maxime BLANGERO, Chungcheongnam-do (KR)

(21) Appl. No.: 19/126,634

(22) PCT Filed: Nov. 2, 2023
(86) PCT No.: PCT/EP2023/080505

§ 371 Date: May 1, 2025

(30) Foreign Application Priority Data
Nov. 3, 2022 (EP) 22205331.6

(51) Int. Cl. C01G 53/44; H01M 4/525

(52) U.S. Cl. CPC C01G 53/44; H01M 4/525; C01P 2006/40

(57) ABSTRACT

A method for preparing a positive electrode active material comprises the steps of:
providing a powder material comprising Li and having a Ni content of at least 60.0 mol % onto a support at a first location of a production line; and
contacting the powder material on the support with an aqueous solution to form a wet powder material at a second location of the production line,
   wherein the method is characterized in that it includes a step of continuously moving the support along a direction from the first location to the second location.

The invention concerns a method for preparing a positive electrode active material for a battery, preferably a positive electrode active material comprising Li and at least 60 mol % Ni.

Such positive electrode active material having a Ni content of at least 60 mol % comprises lithium impurities on its particles surface, for instance, in the form of LiOH and Li₂CO₃. These impurities come from unreacted lithium source with precursor of positive electrode active material during synthesis. In detail, an excess amount of lithium salt(s) is added to the precursor of positive electrode active material to compensate for the lithium loss during calcination due to volatilization of lithium at high temperature. The excessive lithium content from the synthesis will remain at the particle surface and simultaneously react with H₂O, O₂, and CO₂ in the air to form the impurities. Furthermore, the highly reactive Ni³⁺ ions in the positive electrode active material can contribute to the formation of the impurities. In detail, the spontaneous reduction of Ni³⁺ to Ni²⁺ at the particle surface will give rise to lattice oxygen O²⁻ oxidation and the consequent reaction with Li⁺. It can be described by the following equations:

Ni³⁺+O²⁻ (lattice)→Ni²⁺+O⁻ (1)

O⁻+O⁻→O²⁻ (active)+O (2)

O⁻+O→O₂⁻;O+O→O₂ (3)

O²⁻(active)+CO₂/H₂O→CO₃²⁻/OH⁻ (4)

2Li⁺+CO₃²⁻/2OH⁻→Li₂CO₃/2LiOH (5)

The presence of these impurities may lead to a deterioration of the capacity retention, substantial gassing during cell cycling, and a high pH of the electrode coating slurries, which can cause gelation of the slurry during electrode preparation.

These lithium impurities on the surface of the positive electrode active material particles are removed by a so called “washing process” step. A conventional washing process step comprises dumping the positive electrode active material into a tank filled with aqueous solution to form a slurry and stirring the slurry during a substantial amount of time followed by separating said material from the aqueous solution through a filtration process.

However, such typical washing process step is time consuming and has therefore low throughput, since it is a batchwise washing step. In detail, the powder material of the positive electrode active material is dumped into a tank filled with aqueous solution during a substantial amount of time. Thus, the surface treatment of the powder material is not homogeneous, which leads to high variability of the properties of the powder material.

Furthermore, batchwise washing step is not time efficient since intermediate steps such as charging a washing tank with a substantial amount of aqueous solution and cleaning the washing tank should be inserted between the surface treatment of the powder material. Batchwise washing step may also cause an excessive contact of the powder material with aqueous solution, which may lead to surface defects, cation exchange generating several side effects like higher specific surface area, Li extraction from layered structures, etc.

It is therefore an object of the present invention to provide a method to prepare a positive electrode active material having a reduced amount of lithium impurities as compared to that of a non-washed positive electrode active material in a more efficient way. Said method has a high throughput and enables homogeneous exposure time of the positive electrode active material to the aqueous solution, thereby allowing to prepare a cathode active material powder, the physicochemical properties variability of which is minimized after washing step is applied thereto.

### BRIEF DESCRIPTION OF THE FIGURES

By means of further guidance, a figure is included to better appreciate the teaching of the present invention. Said figure is intended to assist the description of the invention and is nowhere intended as a limitation of the presently disclosed invention.

FIG. 1 is an exemplary embodiment of a first aspect of the present invention.

FIG. 2 is a schematic illustration of a first embodiment of a toothed distribution tray according to the present invention.

FIG. 3 is a schematic illustration of a second embodiment of a toothed distribution tray according to the present invention.

### DETAILED DESCRIPTION OF THE INVENTION

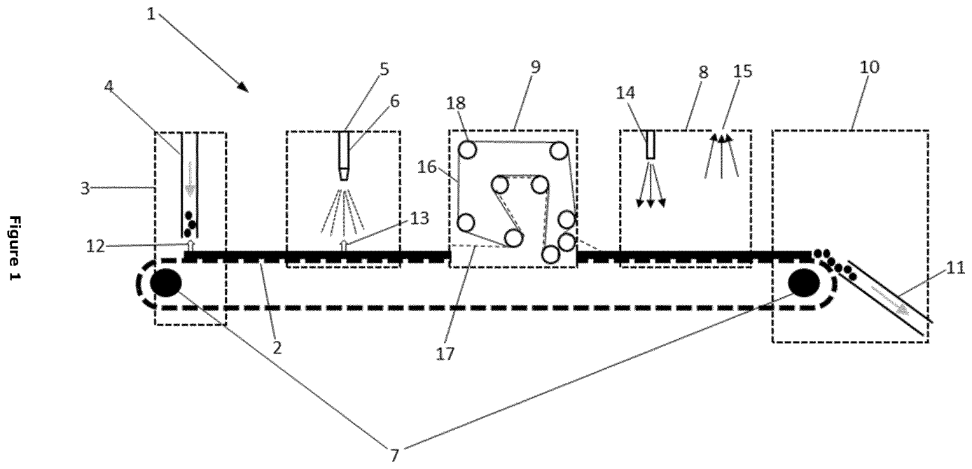

FIG. 1 shows an exemplary embodiment of a first aspect of the present invention. In the first aspect, the present invention concerns a method for preparing a positive electrode active material, comprising the steps of:
providing a powder material comprising Li and having a Ni content of at least 60 mol % onto a support (2) at a first location (12) of a production line (1); and
contacting the powder material lying on the support (2) with an aqueous solution to form a wet powder material at a second location (13) of the production line (1), said support (2) being in continuous movement along a direction from the first location (12) to the second location (13).

The method according to the present invention is time efficient since it is a continuous process, which requires neither charging of aqueous solution nor cleaning. Furthermore, the method according to the present invention allows more homogeneous surface treatment than the method of batchwise washing step because (i) the support (2), onto which the powder material is provided, is continuously moving, and thus, the powder material is contacted with aqueous solution only when the support (2) passes the second location (13), and (ii) the method according to the present invention is easy to control the washing time, and thus, the excessive contact of the powder with aqueous solution may be avoided. In order to ensure the homogeneous surface treatment, the powder material is uniformly spread to form a thin layer over the width of the support (2).

In a preferred embodiment, the powder material comprises Li, O, and M, and, wherein M comprises:
Ni in a content x, wherein x≥60.0 mol %,
Mn in a content y, wherein 0%≤y≤40.0 mol %,
Co in a content z, wherein 0%≤z≤40.0 mol %, and
A in a content p, wherein 0%≤p≤5.0 mol %, wherein A is at least one element other than Li, Ni, Mn, Co, and O,
   wherein x+y+z+p=100.0 mol %.

Preferably, x≥70.0 mol %, more preferably x≥75.0 mol %, and even more preferably x≥80.0 mol %.

Preferably, y≤30.0 mol %, more preferably y≤25.0 mol %, and even more preferably, y≤20.0 mol %.

Preferably, z≤30.0 mol %, more preferably z≤25.0 mol %, and even more preferably, z≤20.0 mol %.

Preferably, p≤4.0 mol %, more preferably p≤3.0 mol %, and even more preferably, p≤2.0 mol %.

Preferably, x, y, z, and p are measured by ICP-OES (Inductively coupled plasma).

In one embodiment, element A is selected from the group consisting of Ag, Al, As, Au, B, Ba, Bi, Ca, Ce, Cd, Cr, Cs, Eu, Fe, Ga, Ge, Hg, Sb, Se, In, Ir, K, La, Mg, Mo, Na, Nb, Nd, Os, P, Pb, Pd, Pr, Pt, Rb, Re, Rh, Ru, S, Sc, Se, Si, Sm, Sr, Ta, Te, Ti, Y, V, W, Zn, and Zr or combinations thereof.

Preferably, element A is selected from the group consisting of Al, As, B, Ba, Ca, Ce, Cd, Cr, Cs, Fe, Ga, Ge, Se, In, Ir, K, Mg, Mo, Na, Nb, Nd, P, Pd, Pt, S, Sc, Se, Si, Sr, Ta, Te, Ti, Y, V, W, Zn, and Zr or combinations thereof.

Even more preferably, element A is selected from the group consisting of Al, B, Ba, Ca, Cr, Fe, Mg, Mo, Nb, S, Si, Sr, Ti, Y, V, W, Zn, and Zr, or combinations thereof.

In the framework of this invention, the term “support” is to be understood as any means destined to bear and retain said powder material during the preparation of positive electrode active material.

In a preferred embodiment, said support (2) is permeable to the aqueous solution. Preferably, the support (2) has pores, each of which has a cross-sectional area smaller than the particle size at 1% of the cumulative volume % distributions (D1) of the powder material, as measured by laser diffraction method. The support (2) with the pores has an advantage that undesired particles or impurities may be removed through the pores.

In a preferred embodiment, at the first location (12) of the production line (1), a powder supply line (4) is placed to distribute the powder material on the support (2). The thickness of the powder material layer ranges preferably from 0.1 cm to 5.0 cm, more preferably from 1.0 cm to 4.0 cm, most preferably from 2.0 cm to 3.0 cm. Said powder supply line (4) may be equipped with a profiling knife in a fixed position between the first location (12) and the second location (13), and above an upper surface of the support (2), whereon the powder is discharged, to ensure better spreading of the powder over the width of the support (2).

Preferably, the gap between the profiling knife and the upper surface of the support (2) is at least 1.0 cm and at most 3.0 cm thereby making the powder thickness evenly spread with the same thickness equivalent to the gap between the profiling knife and the support (2).

In a preferred embodiment, at the second location (13) of the production line (1), the powder material on the support (2) is contacted with the aqueous solution to form a wet powder material.

Preferably, said aqueous solution is water, preferably deionized water. Preferably the aqueous solution temperature is between 10 °C to 50 °C, preferably between 15 °C to 25 °C.

Further, said aqueous solution is discharged through a discharger (6). The discharger (6) may be spray nozzles. The spray nozzles utilize the kinetic energy imparted to the aqueous solution to break it up into droplets such that the aqueous solution should be evenly distributed to the powder material. The spray nozzles may be located vertically above the support (2). The spray nozzles may be aligned with a direction perpendicular to the moving direction of the support (2). The location of the spray nozzles is identical to the second location (13) of the production line (1), where the aqueous solution is discharged through spray nozzles. The spray nozzles may be plain-orifice nozzles, shaped-orifice nozzles, surface-impingement single-fluid nozzles, pressure-swirl single fluid nozzles, solid-cone single-fluid nozzles, or compound nozzles. The number and spacing of the spray nozzles are adjusted such that the aqueous solution should be discharged over the entire top surface of the part of the powder material layer, which is located vertically under the spray nozzles. The spray nozzles may be made from a non-corrosive material.

The spray angle ranges preferably from 20° to 140°, more preferably from 30° to 120°, and most preferably from 45° to 90°. The distance ranges preferably from 5 cm to 100 cm, more preferably from 7 cm to 30 cm, and most preferably from 10 cm to 20 cm.

When the aqueous solution impacts on a surface of the powder material by being discharged through the spray nozzles, slurry may be generated to fill the gaps which might be generated by suctioning the aqueous solution through the support. Accordingly, the cake of the powder material may have no gaps after contacting the powder material with the aqueous solution, and the channeling of the aqueous solution may be prevented. Thus, the content of the impurity in the powder material may be lowered.

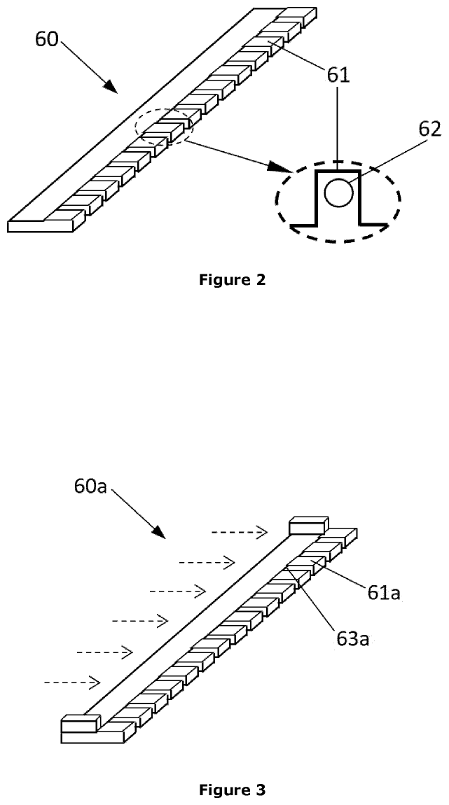

In another embodiment, the discharger (6) may be a toothed distribution tray. FIG. 2 shows a schematic illustration of an embodiment of the toothed distribution tray. The illustration in FIG. 2 encircled by dashed lines is an enlarged drawing of the tooth (61) viewed from its bottom surface. The embodiment of the toothed distribution tray (60) comprises a plurality of tooths (61) aligned with a direction perpendicular to the moving direction of the support (2). The embodiment of the toothed distribution tray (60) has a flat plane having a toothed zigzagged edge with a regular distance between each of the tooths (61). Each of the tooths (61) comprises an outlet (62) of the aqueous solution. The shape of the cross section of the outlet (62) may be a circle, an ellipse, or a polygon such as a square, a rectangle, a pentagon or a hexagon. The area of the outlet (62) ranges preferably from 15 mm² to 2000 mm², more preferably from 100 mm² to 1500 mm², and most preferably from 300 mm² to 700 mm². The flow rate of the aqueous solution at the outlet (62) ranges preferably from 0.01 m³/hr to 10 m³/hr, more preferably from 0.1 m³/hr to 5 m³/hr, most preferably from 1 m³/hr to 3 m³/hr.

FIG. 3 shows a schematic illustration of an embodiment of the toothed distribution tray. The embodiment of the toothed distribution tray (60a) comprises a plurality of tooths (61a) aligned with a direction perpendicular to the moving direction of the support (2). The embodiment of the toothed distribution tray (60a) has a flat plane having a toothed zigzagged edge with a regular gap (63a) between each of the tooths (61a). The aqueous solution supplied from the rear of the tray (60a) flows through the gap (63a) to the powder material.

The supply direction of the aqueous solution is indicated by arrows with dashed lines but is not limited to the illustration in FIG. 3. The flow rate of the aqueous solution at the gap (63a) ranges preferably from 0.01 m³/hr to 10 m³/hr, more preferably from 0.1 m³/hr to 5 m³/hr, most preferably from 1 m³/hr to 3 m³/hr.

Said toothed distribution tray (60, 60a) is stationed in a fixed position vertically above the support (2) such that the impurities on the powder material should be sufficiently removed whereas the powder material should not be scattered. The distance from the toothed distribution tray (60, 60a) to a top surface of the powder material layer ranges preferably from 5 cm to 100 cm, more preferably from 7 cm to 50 cm, and most preferably from 10 cm to 20 cm. The number and spacing of the tooths (61, 61a) are adjusted such that the impurities on the powder material should be sufficiently removed. Said toothed distribution tray (60, 60a) may be made from a non-corrosive material.

In the embodiment of discharging the aqueous solution through the toothed distribution tray (60, 60a), the generation of dust may be lowered. Furthermore, the spatter of the powder material may be lowered.

In another embodiment, said aqueous solution is channeled into a flowing pool, wherein the support (2) transporting the powder material is immersed in the aqueous solution through the pool while the powder material on the support (2) being contacted with the aqueous solution. The support (2) may be permeable to the aqueous solution.

In a preferred embodiment, the support (2) is continuously moving along the direction from the first location (12) to the second location (13) with a speed between 0.5 cm/s to 2 cm/s, preferably the speed is 1 cm/s thereby exposing the powder material to aqueous solution with the duration of at least 30 s and at most 10 minutes.

In a preferred embodiment, suction lines are installed adjacent to the support (2) permeable to the aqueous solution along the second location (13) to facilitate faster penetration of aqueous solution to the powder material. Preferably, the suction lines are also installed adjacent to the support (2) permeable to the aqueous solution behind the second location (13) thereby facilitating a faster aqueous solution removal from the wet powder material.

Furthermore, the method may further comprise the step of evaporating the aqueous solution from the wet powder material. The step of evaporating the aqueous solution may be conducted in a hot gas compartment. The gas in the hot gas compartment is preferably, but not limited to, CO₂-free dry air, N₂ gas, or any inert gas. The hot gas compartment may be a vacuum heater compartment. The temperature inside said vacuum heater compartment is at least 70 °C and at most 300 °C, preferably at least 90 °C and at most 200 °C.

In another embodiment, the method may further comprise the step of separating the aqueous solution from the wet powder material. The step of separating the aqueous solution may be conducted in at least one of a belt filter and a vacuum filter. The belt filter is a pair of filtering cloths, wherein the wet powder material is placed in between of clothes, and wherein the clothes sandwich is passed through a series of rollers to press and remove aqueous solution thereby producing wet cake. The filter cloth is a water permeable material. The vacuum filter is a filter in which the aqueous solution passes through more easily due to a vacuum on the output side of the aqueous solution.

Preferably, the method is conducted in CO₂ free atmosphere except for the step of contacting the powder material on the support (2) with the aqueous solution.

Said atmosphere is preferably, but not limited to, CO₂-free dry air, N₂ gas, or any inert gas.

A second aspect of this invention concerns a positive electrode active material production line (1) comprising:
a support (2);
a supply part (3) comprising a supply line (4) providing a powder material onto the support (2);
a discharging part (5) comprising a discharger (6) of an aqueous solution, wherein the discharger (6) provides the aqueous solution onto the powder material to form a wet powder material; and
at least one driver (7) continuously moving the support (2) along a direction from the supply part (3) to the discharging part (5),
wherein the support (2) extends at least from the supply part (3) to the discharging part (5).

In a preferred embodiment, the powder material has a first content of Li impurities, the wet powder material has a second content of Li impurities, and the second content is lower than the first content. The amount of Li impurities is measured by pH titration, which depends on parameters such as the total soaking time of powder in water.

The positive electrode active material production line (1) may further comprise an evaporator (8) configured to evaporate the aqueous solution from the wet powder material. FIG. 1 illustrates an exemplary embodiment of the present invention, wherein the evaporator (8) is a hot gas compartment. Hot gas is introduced through an inlet pipe (14) into an inside of the evaporator (8) and discharged through an outlet pipe (15).

The positive electrode active material production line (1) may further comprise a separator (9) configured to separate the aqueous solution from the wet powder material. The separator (9) may be disposed between the discharging part (5) and the evaporator (8). FIG. 1 illustrates an exemplary embodiment of the present invention, wherein the separator (9) is a belt filter. The belt filter comprises a filter cloth (16) and rollers (18). The wet powder material on the support (2), which is indicated as a line (17), is squeezed through rollers (18) to separate the aqueous solution from the wet powder material.

The positive electrode active material production line (1) may further comprise an unloading part (10) comprising a recovering line (11) collecting the positive electrode active material.

### Experimental Tests Used in the Examples

The following analysis methods are used in the Examples:

### Measurement of Median Particle Size by Laser Diffraction Method

The particle size distribution (PSD) of the positive electrode active material powder is measured by laser diffraction particle size analysis using a Malvern Mastersizer 3000 with a Hydro MV wet dispersion accessory (https://www.malvernpanalytical.com/en/products/product-range/mastersizer-range/mastersizer-3000 #overview) after having dispersed each of the powder samples in an aqueous medium. In order to improve the dispersion of the powder, sufficient ultrasonic irradiation and stirring is applied, and an appropriate surfactant is introduced. D1 is defined as the particle size at 1% of the cumulative volume % distributions obtained from the Malvern Mastersizer 3000 with Hydro MV measurements.

### Measurement of the Amount of Li Impurities by pH Titration

First, a pH electrode is calibrated. 5 g of positive electrode active material powder is added to 100 g of de-ionized (DI) water in a closed flask and stirred for 10 minutes. The slurry is filtered under suction and about 98-99 g of clear solution is obtained. The filtering takes only a few seconds. 90 g of the clear solution is used for the pH titration experiment, and can be kept in an open 250 ml glass flask. The pH titration starts within 1 minute after finishing the filtering. During the pH titration experiment, the electrode is inserted into the clear solution, which is continuously stirred. After 30 seconds, the addition of acid (0.1M HCl) is started. The acid is added at a rate of 0.5 ml/min. pH data points can be recorded each 3 seconds. The pH titration occurs at room temperature. The pH titration is finished when a value below pH=3.0 is achieved. It is assumed that the Li impurities contains only two contributions: (1) LiOH and (2) Li₂CO₃. A typical pH titration shows 2 inflection points. The first is at about pH 8.4, the second at about pH 4.7. Both inflection points originate from Li₂CO₃ and can be used to calculate the amount of Li₂CO₃. The formulas used to calculate each amount of Li₂CO₃ and LiOH in wt % are as follows:

$${Li}_{2} {CO}_{3} ( wt \% ) = \frac{( V 2 - V 1 ) \times {C}_{HCl} \times {M}_{Li 2 CO 3}}{1000 \times \{ ( {W}_{LiMO 2} \times {W}_{Solution} ) / {W}_{DIwater} \}} \times 100 ( \% )$$

$$LiOH ( wt \% ) = \frac{( 2 \times V 1 - V 2 ) \times {C}_{HCl} \times {M}_{LiOH}}{1000 \times \{ ( {W}_{LiMO 2} \times {W}_{Solution} ) / {W}_{DIwater} \}} \times 100 ( \% )$$

Wherein: V1, V2: ml of acid at inflection point 1, 2 (V2>V1);
C_{Hcl}: concentration of HCl (0.1 mol/L);
W_{LIMO2}: weights of positive electrode active material powder, LiMO₂, used solution and stirred
W_{Solution}: weights of used solution;
W_{Dlwater}: weights of stirred water;
M: molecular weights.

### EXAMPLES

The present invention is further illustrated in the following examples:

### Example 1

EX1.1 is prepared through a solid-state reaction between a lithium source and a transition metal-based source precursor according to the following steps:
Step 1) A transition metal oxidized hydroxide precursor with metal composition of Ni_{0.80}Mn_{0.10}Co_{0.10} is prepared by a co-precipitation process in a large-scale continuous stirred tank reactor (CSTR) with mixed nickel manganese cobalt sulfates, sodium hydroxide, and ammonia.
Step 2) The precursor prepared from Step 1) is heated at 375 °C for 7 hours in an oxidizing atmosphere to obtain a heated precursor.
Step 3) Heated precursor prepared from Step 2) is mixed with LiOH in an industrial blender so as to obtain a first mixture having a lithium to metal ratio of 1.00.
Step 4) The first mixture from Step 3) is heated at 750 °C under a constant oxygen flow for 2 hours to obtain a second heated powder.
Step 5) The second heated powder from Step 4) is re-heated in a tray furnace at 810 °C for 12 hours in an oxidizing atmosphere followed by crushing and sieving process so as to obtain a fired powder labelled as EX1.1.

EX1.3 is a positive electrode active material prepared according to the method of this invention in a production line (1). The production line (1) comprises a powder dispenser unit, a support (2), an aqueous solution discharger (6), and further comprises an evaporator (8) to evaporate aqueous solution from a wet powder material EX1.2.
Step 1) EX1.1 is disposed onto the support (2), which is a conveyer belt, by a powder dispenser unit.
Step 2) EX1.1 disposed on the first location (12) of the support (2) moves to the second location (13) of the support (2) by the conveyer belt line with a moving speed of 1 cm/s. A profiling knife is positioned between the first location (12) and the second location (13), and 2 cm above the upper surface of the support (2) in order to form the homogeneously distributed powder bed of EX1.1. The measured powder bed depth of EX1.1 is 2.0±0.1 cm.
Step 3) The powder bed of EX1.1 is contacted with an aqueous solution which is a deionized water at the second location (13). At the second location (13), the deionized water is discharged on the powder bed of EX1.1 through spray nozzles of the aqueous solution discharger (6) in order to form a wet powder material EX1.2. The temperature of the deionized water before spraying is around 15 °C. The support (2) is a water-permeable material having a pore size of 5 μm, therefore, enabling the aqueous solution to pass through the support (2). The production line (1) further comprises a solution suction line adjacent to the water permeable support (2) to facilitate a faster water removal from the wet powder material EX1.2.
Step 4) The wet powder material EX1.2 is dried in a hot gas compartment at 100 °C. The dried powder is named EX1.3.

### Example 2

EX2.2 is prepared according to the same method as EX1.3 except that at the second location (13), the distributed EX1.1 on the support (2) is contacted with deionized water discharged through the toothed distribution tray (60) to form a wet powder material EX2.1.

Said toothed distribution tray (60) is stationed in a fixed position 10 cm on the top of the support (2) thereby enabling the deionized water to flow steadily onto the distributed powder surface. The deionized water temperature is controlled to 15 °C before being flowed to the tray (60).

### Example 3

EX3 is a dried powder prepared according to the same method as EX1.3 except that EX3 is dried in both belt filter and hot gas compartment.

The belt filter is made from a water permeable material having pore size of 5 μm therefore enabling the aqueous solution to pass through the filter and transforming the wet powder material into a wet cake.

The wet cake from belt filter is passed through a hot gas compartment wherein gas having temperature of 100 °C is flowed through the wet cake. Said gas is CO₂ free dry air.

1-15. (canceled)

16. A method for preparing a positive electrode active material, comprising the steps of:
providing a powder material comprising Li and having a Ni content of at least 60.0 mol % onto a support at a first location of a production line; and
contacting the powder material on the support with an aqueous solution to form a wet powder material at a second location of the production line,
wherein the method includes a step of continuously moving the support along a direction from the first location to the second location.

17. The method according to claim 16, wherein the powder material comprises Li, O, and M, and, wherein M comprises:
Ni in a content x, wherein x≥60.0 mol %,
Mn in a content y, wherein 0%≤y≤40.0 mol %,
Co in a content z, wherein 0%≤z≤40.0 mol %, and
A in a content p, wherein 0%≤p≤5.0 mol %, wherein A is at least one element other than Li, Ni, Mn, Co, and O,
wherein x+y+z+p=100.0 mol %.

18. The method according to claim 16, wherein the aqueous solution is discharged through spray nozzles.

19. The method according to claim 16, wherein the aqueous solution is discharged through a toothed distribution tray.

20. The method according to claim 19, wherein the support is permeable to the aqueous solution.

21. The method according to claim 19, wherein the support is immersed in the aqueous solution during the step of contacting the powder material on the support with the aqueous solution.

22. The method according to claim 16, further comprising evaporating the aqueous solution from the wet powder material.

23. The method according to claim 22, wherein the step of evaporating the aqueous solution is conducted in a hot gas compartment.

24. The method according to claim 23, wherein the hot gas compartment is a vacuum heater compartment.

25. The method according to claim 16, further comprising separating the aqueous solution from the wet powder material.

26. The method according to claim 25, wherein the step of separating the aqueous solution is conducted in at least one of a belt filter and a vacuum filter.

27. The method according to claim 16, wherein the aqueous solution is suctioned through a suction line installed adjacent to the support permeable to the aqueous solution.

28. The method according to claim 16, wherein the aqueous solution is water.

29. A positive electrode active material production line, comprising:
a support;
a supply part comprising a supply line providing a powder material comprising Li and having a Ni content of at least 60.0 mol % onto the support;
a discharging part comprising a discharger of an aqueous solution, wherein the discharger provides the aqueous solution onto the powder material to form a wet powder material; and
at least one driver continuously moving the support along a direction from the supply part to the discharging part,
wherein the support extends at least from the supply part to the discharging part.

30. The positive electrode active material production line according to claim 29, wherein the powder material has a first content of Li impurities, the wet powder material has a second content of Li impurities, and the second content is lower than the first content.
